(19) United States
(12) Patent Application Publication
(10) Pub. No.: US 2017/0322481 A1
(43) Pub. Date: Nov. 9, 2017

(54) HOLDING ELEMENT FOR A CAMERA AND CAMERA ARRANGEMENT, HOLDING ELEMENT AND A HELMET

(71) Applicant: Tormaxx GmbH, Moenchengladbach (DE)

(72) Inventor: Hubert KOCH, Moenchengladbach (DE)

(73) Assignee: Tormaxx GmbH, Moenchengladbach (DE)

(21) Appl. No.: 15/528,193

(22) PCT Filed: Nov. 23, 2015
(86) PCT No.: PCT/DE2015/000551

§ 371 Date: May 19, 2017

(30) Foreign Application Priority Data
Nov. 21, 2014 (DE) 10 2014 017 253.8
May 18, 2015 (CN) 201510253384.2
May 18, 2015 (CN) 201510253528.4
Jul. 1, 2015 (DE) 10 2015 008 333.3

(51) Int. Cl. G03B 17/56; A42B 3/04; F16M 13/04; H04N 5/225

(52) U.S. Cl. CPC G03B 17/561; H04N 5/2252; A42B 3/042; F16M 13/04

(57) ABSTRACT

Brackets for cameras on ski helmets must, on the one hand, hold the camera securely on the helmet and on the other hand, also permit a releasable attachment. To further develop such a bracket, the bracket includes a release unit, which when a defined load on the camera is exceeded, the camera is released from the bracket at a defined point. As a result, the forces occurring in the event of a crash are transferred from the camera via the bracket to the helmet up to a defined limit only. Injuries when wearing the helmet are thus avoided.

The invention relates to a mounting bracket for a camera. In particular the invention relates to a mounting bracket for attaching a camera to a helmet.

Cameras are highly sensitive, usually relatively expensive devices, which for stable support are mounted on stands. Cameras of this kind are, however, also used as film and photo cameras in highly dynamic applications, as in particular, is the case in sports. To this end the camera is for example attached to the helmet of a skier, cyclist or kayaker, in order to take photos during a dynamic application, while securely connected to the helmet.

The fastening devices are designed to fasten the camera securely to the helmet in such a way that even when subjected to dynamic loads it is securely anchored to the helmet. To this end the fastening devices are constantly undergoing further developments, so that good camera brackets ensure that even for highly dynamic loads the camera remains securely attached to the helmet.

The invention is based on the requirement to further develop a bracket of this kind. This requirement is met by a generic bracket which comprises a release unit, which when a defined load on the camera is exceeded, releases the camera from the bracket at a defined point.

Insofar as a static or a dynamic load acts as a force on the camera during dynamic use, this dynamic load is transferred to the helmet as a result of its firm connection with the helmet. The helmet in turn transfers this load to the head of a person to which the helmet is attached. In consequence forces from the helmet act on the head or the neck region, which can lead to serious injury.

This chain of forwarded forces is interrupted, according to the invention, near the point of force introduction on the camera bracket, in order to avoid damage to the helmet and in particular injuries to the person wearing the helmet.

The consequence of this is that the bracket stops supporting the camera when a defined load reached. During highly dynamic use this leads to a release of the camera from the helmet, which as a rule means that the camera is destroyed.

Although the central requirement consists in retaining the camera securely on the helmet, in particular in highly dynamic situations, it is proposed according to the invention to release the connection between camera and helmet precisely in a particularly dynamic situation and accept destruction of the camera. To this end the bracket is provided with a defined point so that neither the helmet nor the camera are damaged, when the camera is released from the bracket.

The defined load is defined by the breaking resistance, which indicates the mechanical stress, which for a uniform increase in load on the bracket leads to breakage. Depending on the type of stress the breaking resistance indicated may be expressed as tensile stress, compressive strength, flexural strength, shear resistance or torsional strength. For a dynamic load this may be indicated as fatigue strength or inert strength.

It is advantageous if the release unit of the camera releases the camera together with a part of the release unit. The release unit is therefore a multi-piece unit permitting a connection between these parts of the release unit, which is interrupted when a defined load is exceeded. Or, as an alternative the release unit can undo the connection directly at the transition between bracket and camera or bracket and helmet.

An advantageous variant of the embodiment provides for the bracket allowing a reversible attachment of the camera on the helmet. The release unit can alter the bracket reversibly or irreversibly in order to separate the camera from the helmet.

A simple variant provides for the release unit to comprise a mounting bracket which, when a defined load on the camera is exceeded, bends in such a way that the camera is released from the bracket. This bending may be realised in a reversible or irreversible manner.

Or a bracket of this kind may comprise a release unit, which has a predetermined breaking point, which when a defined load on the camera is exceeded, breaks thereby releasing the camera from the bracket. Such a predetermined breaking point may be provided on any part of the bracket.

Or the bracket may comprise a magnet and a metal part or two magnets, in order to retain the camera on the bracket or the bracket on a helmet, or in order to hold two parts of the bracket together. This magnetic connection can be used both for fixing and also as a release unit. A simple design of the bracket provides for the magnetic connection to be strong enough to be suitable during normal use to securely retain the camera, and to release the camera in case of a crash in order to avoid injuries. Therefore, according to a further aspect of the invention, which even without the above-mentioned features is essential to the invention, it is proposed that the release unit comprises a magnetic connection, which when a defined load on the camera is exceeded, causes the camera to be released from the bracket.

An advantageous design of the bracket provides for a holding part of the holding device to be designed to attach a camera to the bracket and for a fixing part of the bracket to be designed to attach the holding device to a helmet.

With such a design it is advantageous if the holding part comprises an arm with at least one slot. This slot makes it possible to securely fasten the camera to the bracket in a simple manner.

With such a design of a bracket the fixing part may be configured as a base. For example, the fixing part may comprise an adhesive surface.

An easily releasable connection is achieved in that the holding part can be inserted into the fixing part. It is advantageous if the holding part locks into the fixing part.

A particularly secure connection is achieved if the holding part or the fixing part is fixed by means of a swivel bracket.

It has become evident that a defined load which on the one hand permits secure fastening and on the other avoids negative influences from the helmet on the person wearing the helmet, is a breaking load between 10 and 1000 N, preferably between 100 and 1000 N.

The helmet bracket may be realised in different ways. Advantageous embodiments are the subject of the sub-claims and the drawing.

An advantageous design comprises a base plate made of a tear-resistant but still elastic elastomer, which at the four corners contains recesses for connecting elements. These elements which can be fitted to the base plate may be different from each other depending on the type of helmet and are individually tailored to suit the particular helmet.

Four suction cups which may be firmly connected to the underside of the base plate by vulcanisation, ensure a firm hold for the systems apart from the tension applied at the four attachment points.

The bracket system may be individually modified to suit different applications such as helmets for motor bikes, quad bikes and similar applications, helmets for skaters, dirt bikes and bicycles and similar applications with many cut-outs.

Further development of the invention is based on the requirement, to propose a simple stable bracket system, which in particular permits helmet cameras to be attached to different helmets.

This requirement is met by a bracket system with a base plate made of elastomer, which comprises four connecting elements which extend from the base plate in different directions. The attached figures show exemplary realisations of helmet brackets.

By manufacturing the base plate from an elastomer it is possible to use elastic connecting elements or even non-elastic connecting elements for fastening the base plate to a helmet.

Especially preferable are suction cups, in particular suction cups on the underside of the base plate, which effect a connection between the base plate and the helmet and thus avoid that the base plate shifts relative to the helmet.

It is advantageous for the bracket to comprise a base plate made of elastomer with three, preferably four connecting elements, which extend from the base plate in different directions.

The connecting elements may be releasably attached to the base plate. The base plate is preferably rectangular or square, and the connecting elements are arranged on the corners. The connecting elements may comprise fastening devices which permit fastening under tension to a helmet. With this arrangement it is advantageous if the connecting elements are length-adjustable.

It is especially advantageous if suction cups are arranged on a contact side of the base plate. These suction cups may be arranged in a rectangle or a square and they may be fastened to the base plate so as to be movable.

It is advantageous if a locking device is provided on a contact side of the base plate for fastening a helmet camera, for example.

The forming of connecting elements and suction cups on the bracket is essential to the invention, even without the other features of the base plate and the bracket, in particular without the predetermined breaking point.

The requirement on which the invention is based, is also met by an arrangement of camera bracket and helmet, where when a defined load on the camera is exceeded, the camera is released from the helmet. It is advantageous if when a defined load on the camera is exceeded, the camera is released from the bracket. Besides, it is advantageous if when a defined load on the camera is exceeded, the camera is released from only a part of the bracket.

Advantageous variants of the embodiment of such brackets are shown in the drawing and will now be explained in detail.

I.e.:

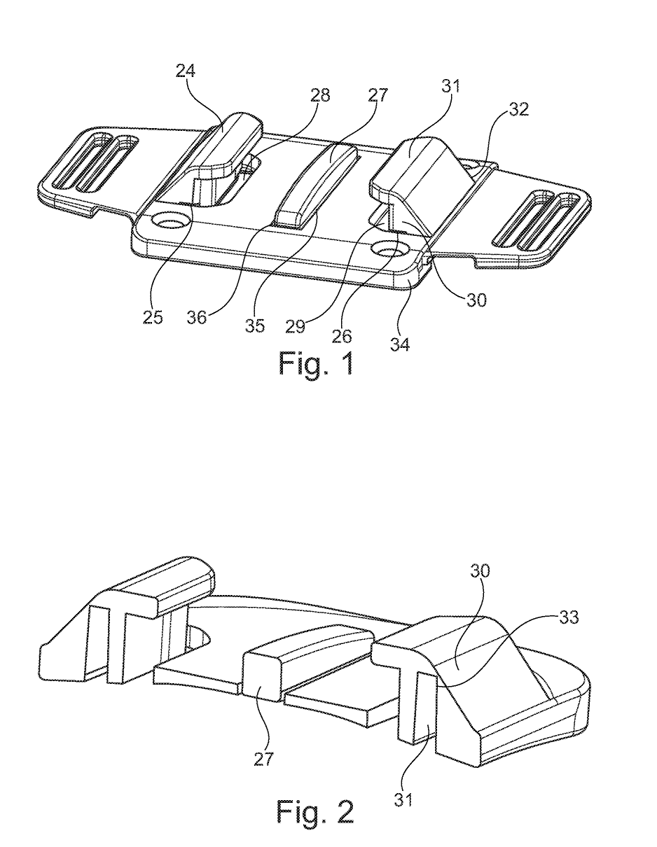

FIG. 1 shows a three-dimensional top view of a fixing part of a bracket,

FIG. 2 shows a section through the fixing part depicted in FIG. 1,

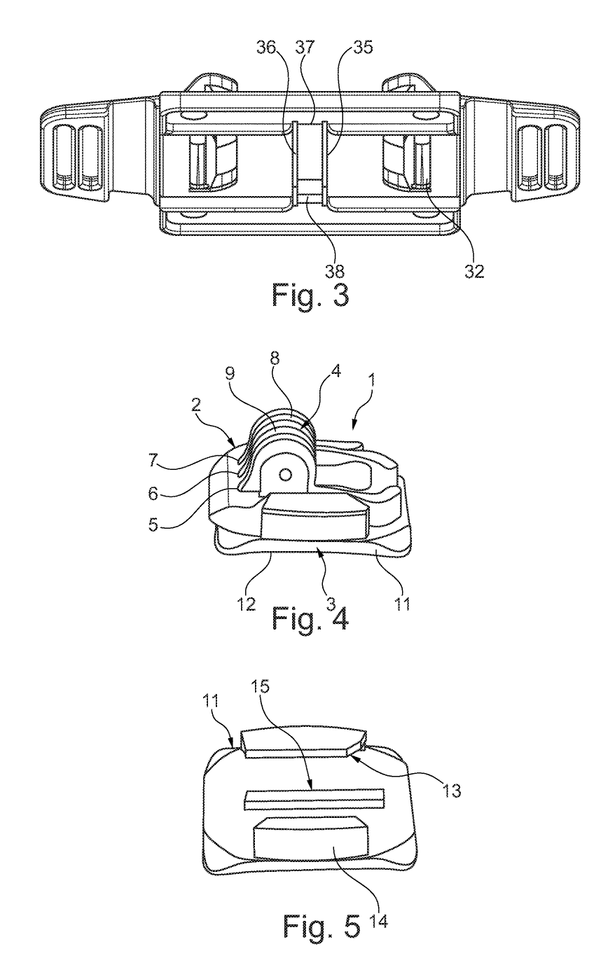

FIG. 3 shows a bottom view of the fixing part depicted in FIG. 1,

FIG. 4 shows a three-dimensional view of a bracket composed of fixing part and holding part,

FIG. 5 shows a top view of the fixing part depicted in FIG. 4,

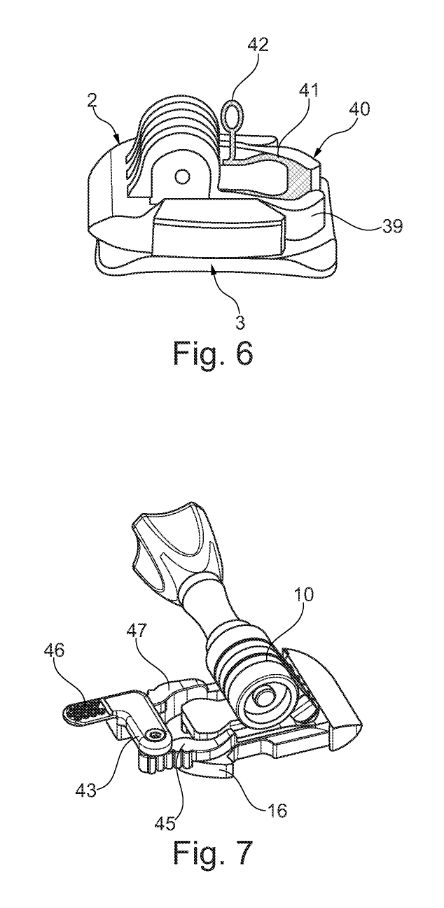

FIG. 6 shows the bracket depicted in figure with a security insert,

FIG. 7 shows a three-dimensional view of a holding part with camera holder,

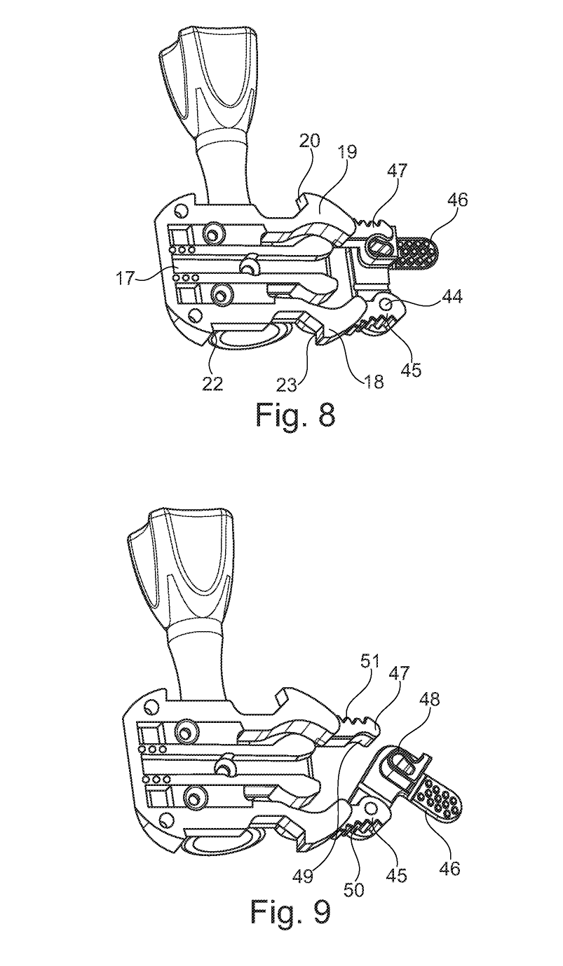

FIG. 8 shows the underside of the holding part depicted in FIG. 7 with closed swivel bracket,

FIG. 9 shows the underside of the holding part depicted in FIG. 7 with open swivel bracket,

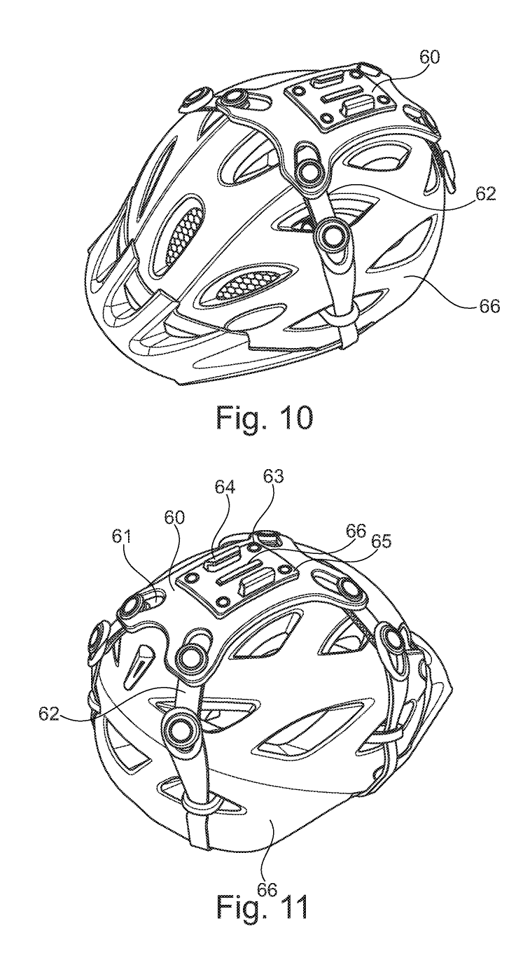

FIG. 10 shows a top view of a helmet from the front with a base plate with connecting elements,

FIG. 11 shows a top view of the helmet depicted in FIG. 10 from behind with base plate,

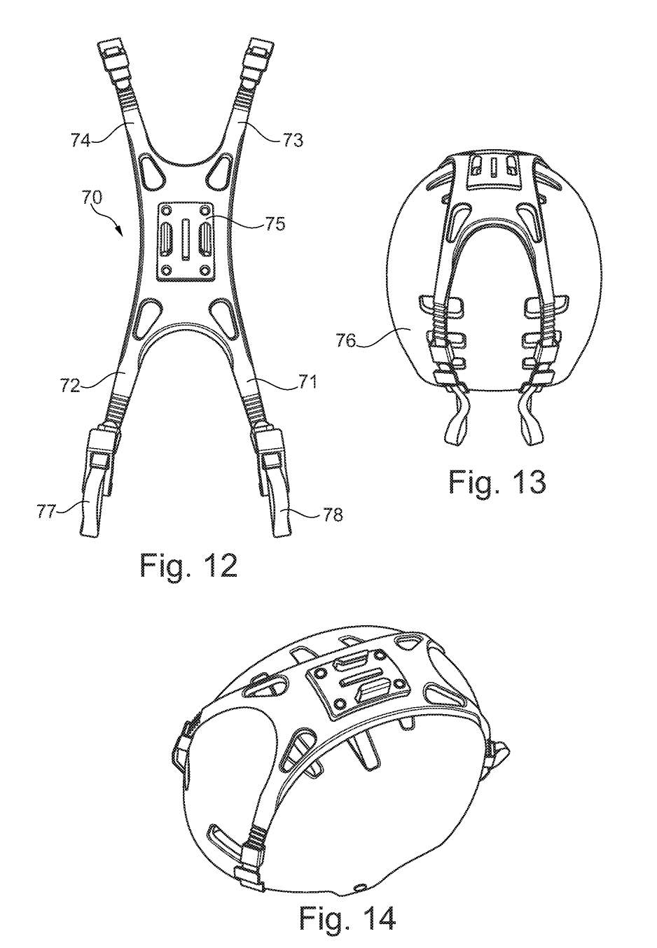

FIG. 12 shows a bracket with four connecting elements,

FIG. 13 shows a top view of a helmet from behind with a bracket as shown in FIG. 12,

FIG. 14 shows a top view of a helmet from the front with a bracket shown in FIG. 12,

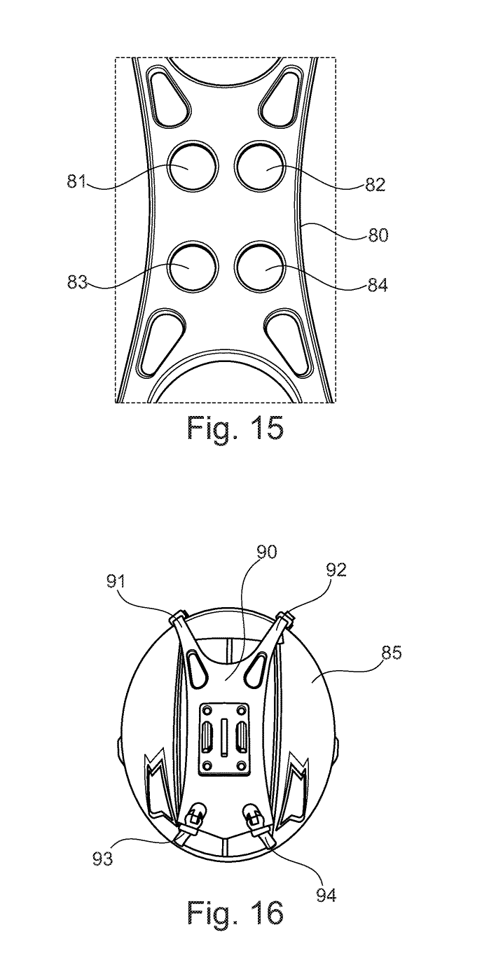

FIG. 15 shows a bottom view of a base plate and

FIG. 16 shows a top view of a helmet with a base plate with two connecting elements extending from the base plate and two hooked-up connecting elements.

The bracket 1 shown consists of a holding part 2 for fastening a camera (not shown) on the bracket 1 and a fixing part 3 for fastening the bracket 1 to a helmet (not shown). To fasten the camera on the holding part, the holding part 2 has an arm 4 with three clamping elements 5, 6 and 7, between which two gaps 8 and 9 are formed (see also FIG. 4).

Two carrier arms of a camera (not shown) can be inserted into the gaps 8 and 9, and a tensioning screw 10 is provided to press the tensioning elements 5 to 7 against each other in such a way that the camera held in the gaps 8 and 9 is firmly connected with the holding part 2.

The fixing part 3 is configured as a base 11 and this base 11 has an adhesive surface 12, with which the base 11 can be firmly connected to a helmet (not shown).

In order to securely connect the base 11 of the fixing part 3 with the holding part 2, the base 11 has two opposing l-shaped retaining bars 13, 14 and in between them a rod-shaped guiding elevation 15. This makes it possible for a holding part such as depicted in FIGS. 4 and 6 as well as FIGS. 8 and 9, to be inserted into the base 11 and to be securely held there. On the underside of the holding part 2 a groove 17 is provided, which, when pushing the holding part 16 into a base 11, corresponds with the guiding elevation 15. When inserting the holding part 16 into a base 11, clamping arms 18, 19 are pressed together as they slide along the retaining bars 13, 14. When the holding part 16 is completely inserted, the retaining bars 13 and 14 are in contact with the holding part 16 between the limits 20 and 23, in order to securely hold the holding part 16 on the base 11.

An alternative embodiment of a fixing part 24 has two retaining bars 25, 26 with a guide 27 between them and breakthroughs 28, 29 below the retaining bars 25, 26. Each retaining bar consists of a vertical holding element 30 and a horizontal holding element 31. A cavity 31 is provided in the vertical holding element 30. The retaining bars 25 and 26 are weakened by a predetermined breaking point 32 or 33 such that either the horizontal holding element 31 breaks away from the vertical holding element 30 or the vertical holding element 31 breaks out of the base plate 34 of the fixing part 24. Because of the gaps 35 and 36 between guide 27 and base plate 34 the guide 27 can also easily break out at the connecting areas 37, 38. To this end the wall thickness of the breaking regions is reduced to 0.1 to 1 mm respectively.

FIG. 6 shows a holding part 2, which is inserted onto the fixing part 3 and therefore firmly connected with it. Following insertion the clamping parts 39 and 40 relax, so that an insertion element 41 can be inserted into the cavity between the clamping arms 39, 40. This will prevent the clamping arms 39 and 40 being squeezed together. It is not until the insertion element 41 is removed by means of the handle 42, that the clamping arms 39 and 40 can be squeezed together, in order to push the holding part 2 out of the retaining bars 13 and 14 and release it from the fixing part 3.

An alternative security device is shown in the FIGS. 7 to 9. Here a swivel bracket 43 movable about a rotary axis 44 is fastened to a clamping arm 45.

This swivel bracket 43 has a handle piece 46, with which it can be swivelled between two clamping arms 45 and 47 such that a locking tab 48 engages in a recess 49 in order to fix the swivel bracket 43 between the clamping arms 45 and 47.

In order to ensure an anti-slip grip when the clamping arms 45 and 47 are squeezed together, a structuring 50, 51 is provided on the outside of the clamping arms 45 and 47.

FIG. 10 shows a base plate 60 with four lugs 61, from which connecting elements 62 are suspended. The base plate 60 has a holding part 63 with holding brackets 64 and 65 and a guiding elevation 66 between them. The holding part 63 is riveted to the base plate 60 and arranged to hold a camera with an intermediate part (not shown). The connecting elements are length-adjustable and slightly elastic in order to attach the base plate 60, which is also slightly elastic, to the helmet 66.

An alternative base plate 70 is shown in FIG. 12. It has four connecting elements 71 to 74 formed in one piece with the base plate 70 and a holding part on the base plate 70, which is configured in the same way as the holding part 63 shown in FIG. 10. In order to attach the base plate to a helmet 76, two connecting elements 73 and 74 can be attached to one side of the helmet, then the base plate 70 is pulled over the helmet 76 and thereafter the two other connecting elements 71 and 72 can be attached to the helmet using holding straps 77 and 78, so that the base plate 70 is tightly strapped to, and in contact with, the helmet 76.

FIG. 15 shows the underside of a base plate 80 with four suction cups 81 to 84. These suction cups are arranged roughly under the holding plate and are used to firmly connect the base plate 80 with the outer smooth surface 85 of the helmet.

A further example of a base plate is shown in FIG. 16 and this base plate 90 has two connecting elements 91 and 92 extending from the base plate and formed in one piece with the base plate. Two hooked-up connecting elements 93 and 94 serve as connection for the base plate with the helmet 85 on the other side.

1. A bracket (1) for a camera, wherein it comprises a release unit, which when a defined load on the camera is exceeded, releases the camera from the bracket at a defined point.

2. The bracket according to claim 1, wherein the release unit releases the camera together with a holding part (2, 16) of the release unit.

3. The bracket according to claim 1, wherein the release unit comprises a mounting bracket (13, 14), which when a defined load on the camera is exceeded, bends in such a way that the camera is released from the bracket (1).

4. The bracket according to claim 1, wherein the release unit comprises a predetermined breaking point (32, 33, 37, 38), which when a defined load on the camera is exceeded, breaks thereby releasing the camera from the bracket (1).

5. The bracket according to claim 1, wherein the release unit comprises a magnetic connection, which when a defined load on the camera is exceeded, releases the camera from the bracket (1).

6. The bracket according to claim 1, wherein a holding part (2, 16) is designed for fastening the camera to the bracket (1) and a fixing part (3, 24) is designed for fastening the bracket (1) to a helmet.

7. The bracket according to claim 6, wherein the holding part (2, 16) comprises an arm (5, 6, 7) with at least one slot (8, 9).

8. The bracket according to claim 6, wherein the fixing part (3, 24) is designed as a base (11).

9. The bracket according claim 6, wherein the fixing part (3, 24) comprises an adhesive surface (12).

10. The bracket according to claim 6, wherein the holding part (2, 16) can be inserted into the fixing part (3, 24).

11. The bracket according to claim 10, wherein the holding part (2, 16) locks into the fixing part (3, 24).

12. The bracket according to claim 10, wherein the holding part (2, 16) or the fixing part (3, 24) can be fixed with a swivel bracket (43).

13. The bracket according to claim 1, wherein the defined load is a breaking load between 10 N and 1000 N.

14. A bracket in particular according to claim 1, wherein it comprises a base plate made of an elastomer with three, preferably four connecting elements, which extend from the base plate in different directions.

15. The bracket system according to claim 14, wherein the connecting elements are releasably fastened to the base plate.

16. The bracket system according to claim 14, wherein the base plate is rectangular or square and the connecting elements are arranged at the corners.

17. The bracket system according to claim 14, wherein the connecting elements have fastening elements, which allow them to be fastened to a helmet under tension.

18. The bracket system according to claim 14, wherein the connecting elements are length-adjustable.

19. The bracket system according to claim 14, wherein suction cups are arranged on a contact side of the base plate.

20. The bracket system according to claim 19, wherein the suction cups are arranged to form a rectangle or a square.

21. The bracket system according to claim 16, wherein the suction cups are attached to the base plate so as to be movable.

22. The bracket system according to claim 14, wherein on one holding side of the base plate, it comprises a locking device for attaching for example a helmet camera.

23. An arrangement of camera, bracket and helmet, wherein, when a defined load on the camera is exceeded, the camera is released from the helmet.

24. The arrangement according to claim 23, wherein, when a defined load on the cameras is exceeded, the camera is released from the bracket.

25. The arrangement according to claim 24, wherein, when a defined load on the camera is exceeded, the camera is released from a holding part (2, 16) of the bracket (1).
